(19) United States
(12) Patent Application Publication
(10) Pub. No.: US 2006/0072931 A1
(43) Pub. Date: Apr. 6, 2006

(54) Heat-fixing device

(76) Inventors: Kenji Asakura, Kyoto (JP); Keisuke Fujimoto, Osaka (JP); Masaru Imai, Osaka (JP); Noboru Katakabe, Kyoto (JP)

Correspondence Address: GREENBLUM & BERNSTEIN, P.L.C., 1950 ROLAND CLARKE PLACE, RESTON, VA, 20191, US

(21) Appl. No.: 10/544,936

(22) PCT Filed: Feb. 20, 2004
(86) PCT No.: PCT/JP04/01987

§ 371 Date: Aug. 10, 2005

(30) Foreign Application Priority Data
Feb. 20, 2003 (JP) 2003-043129

(51) Int. Cl. G03G 15/20

(52) U.S. Cl. 399/33

(57) ABSTRACT

A heat-fixing apparatus is provided that enables a rise in temperature of a heating member to be closely tracked, and an excessive rise in temperature of the heating member to be obviated, a simple configuration and irrespective of differences in the operating mode, such as immediately after a rise in temperature or during continuous operation. Different threshold values are set in accordance with different modes, such as a warm-up mode and a fixing operation mode. Threshold decisions on a switching frequency controlled by a frequency control section are made using different threshold values, according to the mode. A switching frequency of switching elements are varied so that power necessary in each mode is supplied to an exciting coil. An excessive rise in temperature is prevented in each mode by halting a switching element drive in accordance with the threshold decision.

### TECHNICAL FIELD

The present invention relates to a heat-fixing apparatus, and is suitable for application to a heat-fixing apparatus that fixes unfixed toner by means of heating used in a copier, printer, facsimile, or the like, for example.

### BACKGROUND ART

A heat-fixing apparatus of this kind uses heat and pressure to fix toner attached to recording paper by means of an exposure apparatus and transfer roller, for example. Heretofore, a heat-fixing apparatus that uses induction heating has been proposed as one such heat-fixing apparatus.

This heat-fixing apparatus using induction heating performs induction heating, by means of an induction field, of a heating member such as a heat-producing belt located in the vicinity of an exciting coil, by passing a high-frequency current through the exciting coil. Then, toner on the recording paper is heated and fixed using the induction-heated heating member. In comparison with a heat-fixing apparatus that uses a halogen lamp, a heat-fixing apparatus that uses induction heating can selectively heat only a heat-producing medium, enabling heat production efficiency to be increased and the heat-fixing apparatus startup time to be shortened, the power consumption of the overall apparatus to be reduced, and higher speed to be achieved.

In a heat-fixing apparatus, the heating member may be damaged if the temperature of the heating member is raised too high, and it is therefore necessary to prevent an excessive rise in temperature of the heating member. In a heat-fixing apparatus that uses induction heating, in particular, the temperature of the heating member can be raised sharply, and therefore a technique for preventing an excessive rise in temperature is important, and various kinds of contrivances have heretofore been implemented. One such example is the heat-fixing apparatus disclosed in Unexamined Japanese Patent Publication No. HEI 8-190300 (Patent Document 1).

As shown in FIG. 1, in the heat-fixing apparatus disclosed in Patent Document 1, an exciting coil 4 is located, supported by a supporting member 3, inside magnetic metallic film 2 mounted on a guide 1, and a pressure roller 5 is rotated while pressing against magnetic metallic film 2. In this state, recording paper 6 is transported to the nip area between pressure roller 5 and driven magnetic metallic film 2, and unfixed toner 7 on recording paper 6 is fixed. The resistivity of magnetic metallic film 2 is calculated from the current and voltage flowing in exciting coil 4 at this time, and the temperature is detected from the calculated resistivity. Then temperature control is performed by controlling the on-duty ratio of the power supplied to exciting coil 4 in accordance with the detected temperature.

By performing the temperature control disclosed in Patent Document 1 in this way, variations in the temperature of a heating member can be closely tracked, enabling an excessive rise in temperature of the heating member to be obviated. Also, since the temperature can be detected according to the current flowing in the exciting coil, it is possible to obtain a detection result closer to the actual temperature of the heating member than in the case of a temperature sensor, enabling an excessive rise in temperature of the heating member to be prevented more dependably.

It is also possible to cope with a situation where space limitations prevent the installation of a temperature sensor in the vicinity of a heating member. That is to say, when a sensor is installed at a distance from the heating member, if the heat-producing member stops rotating due to the occurrence of an abnormal state the temperature cannot be detected, and the heating member will rise excessively in temperature. Using the technique disclosed in Patent Document 1 enables these problems to be resolved satisfactorily.

However, problems with the above-described heat-fixing apparatus of Patent Document 1 are that, since the resistivity of magnetic metallic film is calculated and temperature is detected from the calculated resistivity, the amount of computing increases and the circuit configuration becomes more complex. Also, if there is nonuniformity in the magnetic metallic film, a difference arises between the detected temperature and the actual temperature, and therefore this heat-fixing apparatus is inadequate in terms of preventing an excessive rise in temperature of the magnetic film.

Furthermore, even though the exciting coil is located in the vicinity of the magnetic metallic film, a certain amount of time is required for the heat of the magnetic metallic film to be conveyed to the exciting coil, and the temperature of the magnetic metallic film and the temperature of the exciting coil are not necessarily the same.

That is to say, the magnetic metallic film is heated in a short time, but the exciting coil is not heated in a short time. There are consequently cases where the temperature of the magnetic metallic film and the temperature of exciting coil are different. For example, immediately after a rise in temperature, the magnetic metallic film is at a predetermined fixing temperature but the exciting coil is at room temperature. On the other hand, after a long period of use, the heat of the magnetic metallic film is fully conveyed to the exciting coil, and therefore the magnetic metallic film and exciting coil are both at the same fixing temperature.

Differences in the temperature of the exciting coil cause variations in the electrical resistance of the exciting coil, and also variations in the permeability of the core of the exciting coil. Therefore, the relationship between the voltage and current of the exciting coil does not only depend on the temperature of the magnetic metallic film, but is also greatly affected by other factors. As a result, it is not easy to measure the temperature of the magnetic metallic film accurately.

### DISCLOSURE OF INVENTION

It is an object of the present invention to provide a heat-fixing apparatus that enables a rise in temperature of a heating member to be closely tracked, and an excessive rise in temperature of the heating member to be obviated, by means of a simple configuration and irrespective of differences in the operating mode, such as immediately after a rise in temperature or during continuous operation.

According to one aspect of the present invention, a heat-fixing apparatus having a plurality of operating modes for induction-heating a heating member by means of an induction field and fixing a heated image to recording paper has an exciting circuit that supplies a high-frequency current in accordance with set power corresponding to the operating mode, and an exciting coil that generates an induction field by the supply of a high-frequency current from the exciting circuit; wherein the exciting circuit sets a threshold value relating to that operating state amount based on the set power, compares the operating state amount when a high-frequency current is supplied with the threshold value, and halts or suppresses the high-frequency current supply according to the result of the comparison.

### BRIEF DESCRIPTION OF DRAWINGS

FIG. 1 is a drawing showing an example of the configuration of a conventional heat-fixing apparatus;

FIG. 2 is a drawing showing the overall configuration of an image forming apparatus in which a heat-fixing apparatus of the present invention is applied;

FIG. 3 is a drawing showing the configuration of heat-fixing apparatus of Embodiment 1;

FIG. 4 is a drawing providing an explanation of an induction heating operation by a heat-fixing apparatus;

FIG. 5 is a drawing of a heat-fixing apparatus view distribution from the direction indicated by arrow E in FIG. 3;

FIG. 6 is a connection diagram showing the configuration of an exciting circuit according to Embodiment 1;

FIG. 7 is a characteristic graph showing the relationship between drive frequency and input power in the exciting circuit in FIG. 6;

FIG. 8 is a flowchart providing an explanation of the operation of Embodiment 1;

FIG. 9A is a graph showing variation of the set power in accordance with operation of a heat-fixing apparatus according to Embodiment 1;

FIG. 9B is a graph showing variation of the measured temperature in accordance with operation of a heat-fixing apparatus according to Embodiment 1;

FIG. 9C is a graph showing variation of the control frequency in accordance with operation of a heat-fixing apparatus according to Embodiment 1;

FIG. 10 is a connection diagram showing the configuration of an exciting circuit according to Embodiment 2;

FIG. 11 is a characteristic graph showing the relationship between drive frequency and detected voltage in the exciting circuit in FIG. 10;

FIG. 12A is a graph showing variation of the set power in accordance with operation of a heat-fixing apparatus according to Embodiment 2;

FIG. 12B is a graph showing variation of the measured temperature in accordance with operation of a heat-fixing apparatus according to Embodiment 2;

FIG. 12C is a graph showing variation of the detected voltage in accordance with operation of a heat-fixing apparatus according to Embodiment 2;

FIG. 13 is a connection diagram showing the configuration of an exciting circuit according to Embodiment 3;

FIG. 14 is a connection diagram showing the configuration of an exciting circuit according to Embodiment 4; and

FIG. 15 is a graph providing an explanation of the operation of a heat-fixing apparatus according to Embodiment 5.

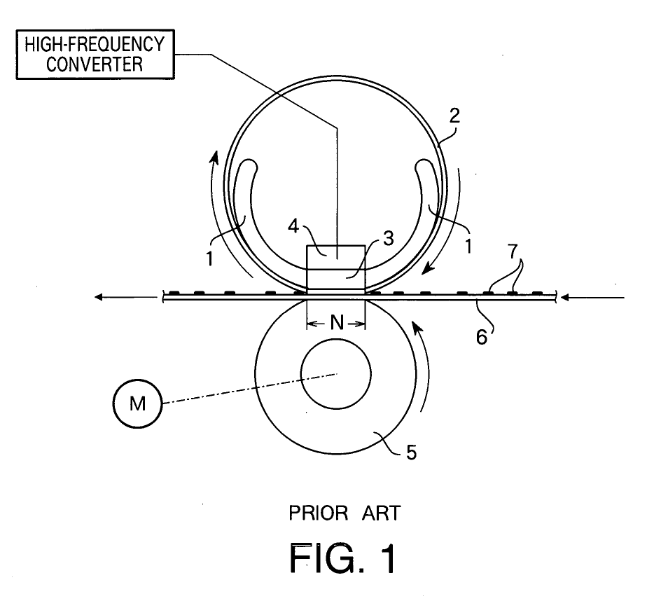

### BEST MODE FOR CARRYING OUT THE INVENTION

The present inventors reached the present invention by noting that there are a plurality of operating modes, such as warm-up mode and fixing operation mode, in a heat-fixing apparatus, and the power supplied from the exciting circuit to the exciting coil and the degree of heat transfer from the heating member to the exciting coil differ in each operating mode, and considering that an excessive rise in temperature of the heating member can be prevented by means of a simple configuration by setting a threshold value for determining the occurrence of an excessive rise in temperature for each operating mode, making a threshold decision using the variation state amount in the exciting coil that varies in order to supply fixed power in each mode and an operating state amount (such as the switching frequency or applied voltage, for example) in the exciting coil that varies according to temperature variations of each member, and halting or suppressing the current supply.

The gist of the present invention is that when different threshold values are set for a plurality of operating modes for which the supplied power value differs, and power is maintained steadily and a high-frequency current is supplied to the exciting coil, a threshold decision is made on the frequency or applied voltage, for example, of the high-frequency current actually supplied to the exciting coil using the threshold value corresponding to that power value, and the high-frequency current supply is halted or suppressed according to the result.

An example of preferable supply halting (suppression) control would be where, in a mode in which the speed of a rise in temperature is fast, such as during the warm-up period, a threshold decision is made on the frequency or applied voltage of the high-frequency current supplied to the exciting coil, and the high-frequency current supply is cut off according to the result, while in a mode in which temperature variations are gradual, such as during a fixing operation period, the high-frequency current supply is cut off using the characteristics of a thermostat.

With reference now to the accompanying drawings, embodiments of the present invention will be explained in detail below.

### Embodiment 1

(1) Overall Configuration

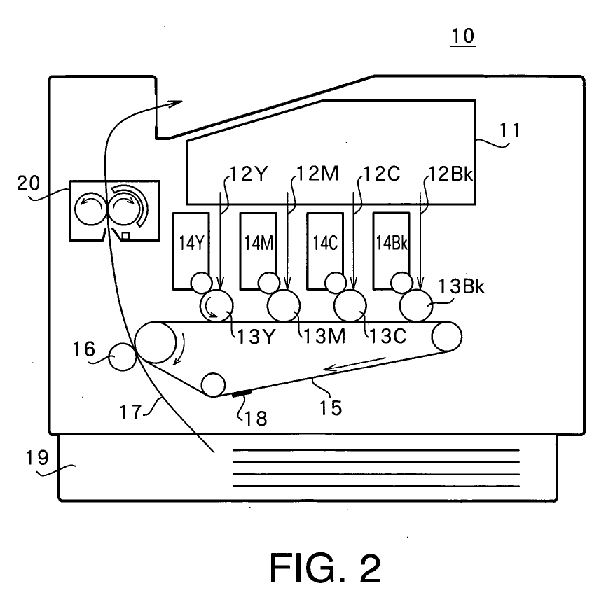

FIG. 2 shows the overall configuration of an image forming apparatus. In image forming apparatus 10, four laser beams 12Y, 12M, 12C, and 12Bk corresponding to image signals are output from an exposure section 11. As a result, latent images are formed by laser beams 12Y, 12M, 12C, and 12Bk on photosensitive bodies 13Y, 13M, 13C, and 13Bk. Developing units 14Y, 14M, 14C, and 14Bk develop the latent images on photosensitive bodies 13Y, 13M, 13C, and 13Bk by applying toner. There are four combinations—Y, M, C, and Bk—of these photosensitive bodies and developing units, with toner of four colors—yellow, magenta, cyan, and black—contained in developing units 14Y, 14M, 14C, and 14Bk respectively. Y, M, C, and Bk are appended to the numbers indicating the above-described members for each color.

Four-color toner images 18 formed on photosensitive bodies 13Y, 13M, 13C, and 13Bk are superimposed on the surface of an intermediate transfer belt 15 that is supported by supporting spindles and moved in the direction indicated by the arrow in FIG. 2. The resulting toner image 18 is transferred to recording paper 17 at the location of a secondary transfer roller 16.

Secondary transfer roller 16 is installed so as to be adjacent to intermediate transfer belt 15. Secondary transfer roller 16 transfers toner image 18 superimposed on intermediate transfer belt 15 to recording paper 17 through the application of an electrical field while recording paper 17 is gripped under pressure between secondary transfer roller 16 and intermediate transfer belt 15. A paper feed unit 19 feeds recording paper 17 at appropriate timing.

Recording paper 17 to which toner image 18 has been transferred is transported to a heat-fixing apparatus 20. Heat-fixing apparatus 20 fixes toner image 18 to recording paper 17 by applying heat and pressure to recording paper 17 to which toner image 18 has been transferred at a fixing temperature of 170° C.

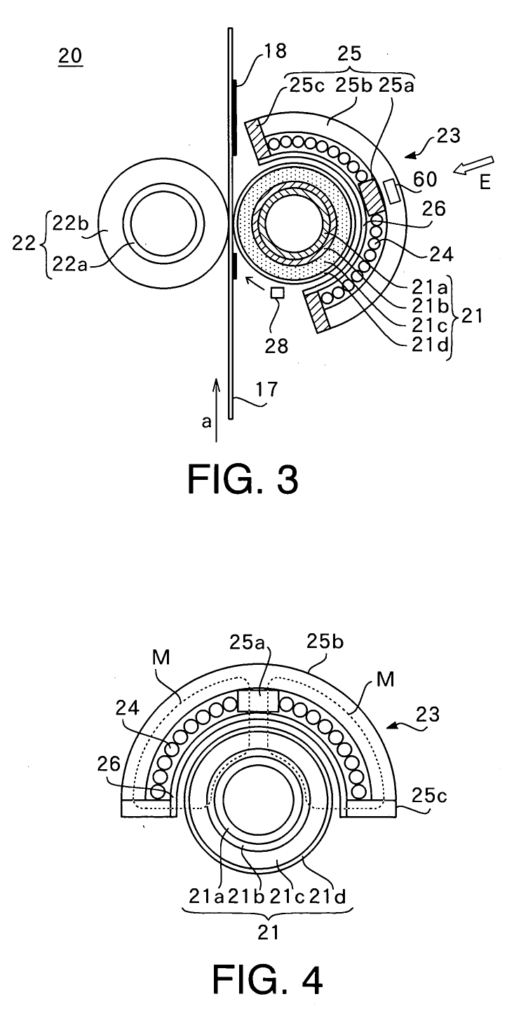

FIG. 3 shows the configuration of heat-fixing apparatus 20 according to Embodiment 1. Heat-fixing apparatus 20 comprises a heat-producing roller 21 supported rotatably by a rotating shaft (not shown), a pressure roller 22 that applies pressure to recording paper 17 gripped between pressure roller 22 and heat-producing roller 21, and an excitation unit 23 that is installed along the peripheral surface of heat-producing roller 21 and has an exciting coil 24 for induction heating of a heat-producing belt 21d functioning as a heating member fitted to the surface of heat-producing roller 21 internally.

Thus, heat-fixing apparatus 20 of this embodiment is provided with an excitation unit 23 on the outside of heat-producing roller 21, and is configured so that heat-producing belt 21d of heat-producing roller 21 is induction-heated by external excitation unit 23.

The detailed configuration of heat-producing roller 21, pressure roller 22, and excitation unit 23 will now be described. Heat-producing roller 21 is of laminated construction, with a magnetic layer 21b of insulating material, and a highly adiabatic and elastic sponge layer 21c, overlaying a hollow core 21a of aluminum or the like. Heat-producing belt 21d is fitted to the surface of heat-producing roller 21. In heat-producing belt 21d, an elastic layer and release layer are formed sequentially upon an aluminum base material functioning as an inductive heat-producing layer. Heat-producing belt 21d is induction-heated by an induction field from exciting coil 24 installed inside excitation unit 23.

In this embodiment, aluminum, which has a high degree of electrical conductivity, is used as the heat-producing layer, and the magnetic circuit described later herein also has good characteristics. This embodiment therefore has characteristics such that the impedance real component of exciting coil 24 varies greatly in the direction of increase due to a rise in temperature of the heat-producing layer. The material of heat-producing belt 21d is not limited to aluminum, and a material with a high degree of electrical conductivity such as copper, silver, or gold may also be used. Alternatively, a material whose electrical conductivity has been improved may be used, such as resin or a similar insulating material combined with a highly electrically conductive material, or a metallic material with a medium degree of electrical conductivity such as nickel of a predetermined thickness (for example, 30 μm or more) may be used. Depending on the specifications, it is possible to obtain impedance-temperature characteristics with the same kind of trend as aluminum using any of these materials.

Heat-producing belt 21d may be bonded to sponge layer 21c to form an integral unit, or may simply be fitted around the perimeter of sponge layer 21c. Also, the induction heating layer may be formed directly upon sponge layer 21c.

Pressure roller 22 is composed of a core 22a and a silicone rubber layer 22b, and presses against heat-producing belt 21d, forming a fixing nip. Pressure roller 22 is rotated by a drive section (not shown) of the main body of the apparatus. Heat-producing roller 21 is thereby rotated, and recording paper 17 gripped between heat-producing roller 21 and pressure roller 22 is moved in the direction indicated by arrow a in the drawing. At this time, toner image 18 on recording paper 17 is fixed by being heated by heat-producing belt 21d and being subjected to pressure by heat-producing roller 21 and pressure roller 22.

Excitation unit 23 has an arc-shaped overall cross-section. A rear core 25 is provided on its outer circumference, and a coil supporting member 26 on its inner circumference, and exciting coil 24 is provided between rear core 25 and coil supporting member 26.

Exciting coil 24 is formed by bundling a predetermined number of wire elements comprising conductive wires with an insulated surface, and stretching and coiling these in the axial direction of heat-producing roller 21. In other words, exciting coil 24 is fitted so that wire bundles are in close mutual contact along the circumferential direction of heat-producing belt 21d so as to cover heat-producing belt 21d. The ends of exciting coil 24 are built up by overlapping wire bundles, and are in the form of a mound overall. Exciting coil 24 is positioned so that a gap of approximately 3 mm is formed between exciting coil 24 and the outer peripheral surface of heat-producing belt 21d.

As exciting coil 24 is thus positioned in the extremely close vicinity of heat-producing belt 21d, when the temperature of heat-producing belt 21d rises, the rise in temperature of exciting coil 24 tracks that rise in temperature closely.

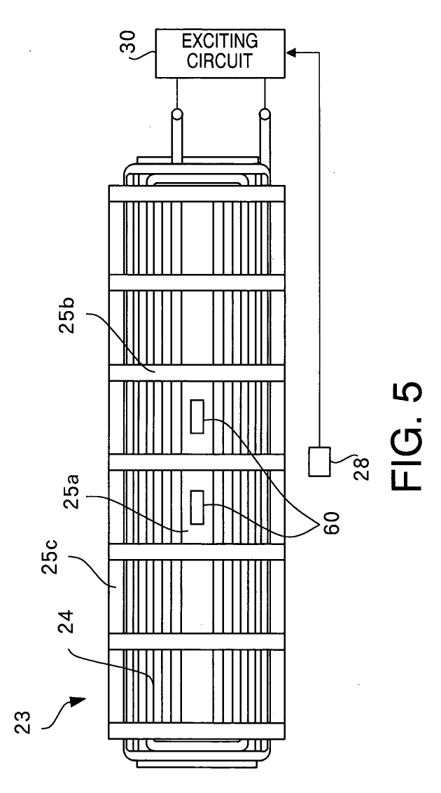

Rear core 25 is composed mainly of ferrite, for example, and comprises a center core 25a located on the inner periphery of the coil turns, arch-shaped arch cores 25b, and a front core 25c located on the outer periphery of exciting coil 24. As shown in FIG. 5, viewed from the direction indicated by arrow E in FIG. 3, a predetermined number of (for example, seven) arch cores 25b are arranged at intervals on the rear surface of exciting coil 24. Center core 25a, front core 25c, and arch cores 25b consecutive in the axial direction are formed by a combination of a plurality of members respectively. Other than ferrite, the material of rear core 25 should preferably be a material such as permalloy with high permeability and resistivity.

Coil supporting member 26 is of 1.5 mm thick resin with a high heat-resistant temperature such as PEEK (polyetheretherketone) or PPS (polyphenylene sulfide) and supports exciting coil 24.

In addition to this configuration, heat-fixing apparatus 20 has a temperature sensor 28. Temperature sensor 28 is installed at the position at which heat-producing roller 21 leaves excitation unit 23, and can detect the temperature of heat-producing belt 21d after induction heating.

The operation whereby heat-producing belt 21d is induction-heated by excitation unit 23 will now be described using FIG. 4 and FIG. 5.

A high-frequency current that has a predetermined frequency is supplied to exciting coil 24 from an exciting circuit 30 (FIG. 5). This frequency should preferably be selected from a frequency range of approximately 20 to 100 kHz according to the properties of the base material of heat-producing belt 21d. For example, if the base material of heat-producing belt 21d is aluminum, a frequency of approximately 60 kHz is selected. Exciting circuit 30 controls the power of the high-frequency current supplied to exciting coil 24 based on a temperature signal obtained from temperature sensor 28 so that the surface temperature of heat-producing belt 21d becomes the predetermined fixing temperature (for example, 170 degrees Celsius).

Flux generated by exciting coil 24 due to the high-frequency power supply from exciting circuit 30 penetrates heat-producing belt 21d from front core 25c and reaches magnetic layer 21b as shown by the dotted lines in FIG. 4. Because of the magnetism of magnetic layer 21b, magnetic flux M passes through the interior of magnetic layer 21b in a circumferential direction. Flux M then passes through heat-producing belt 21d again and forms an alternating field making a loop via center core 25a. An induction current generated by variations in this magnetic flux flows in the base material layer of heat-producing belt 21d, and generates Joule heat. Magnetic layer 21b is not induction-heated as it is insulative.

As magnetic flux M does not reach core 21a of heat-producing roller 21, induction heating energy is not used directly for heating of core 21a. Also, as heat-producing belt 21d is supported by highly adiabatic sponge layer 21c, the outflow of heat from heat-producing belt 21d is small. Therefore, the thermal capacity of heated parts is low, and thermal conductivity is also low, enabling heat-producing belt 21d to be raised to the desired temperature (for example, the fixing set temperature) in a short time.

(2) Configuration of Exciting Circuit

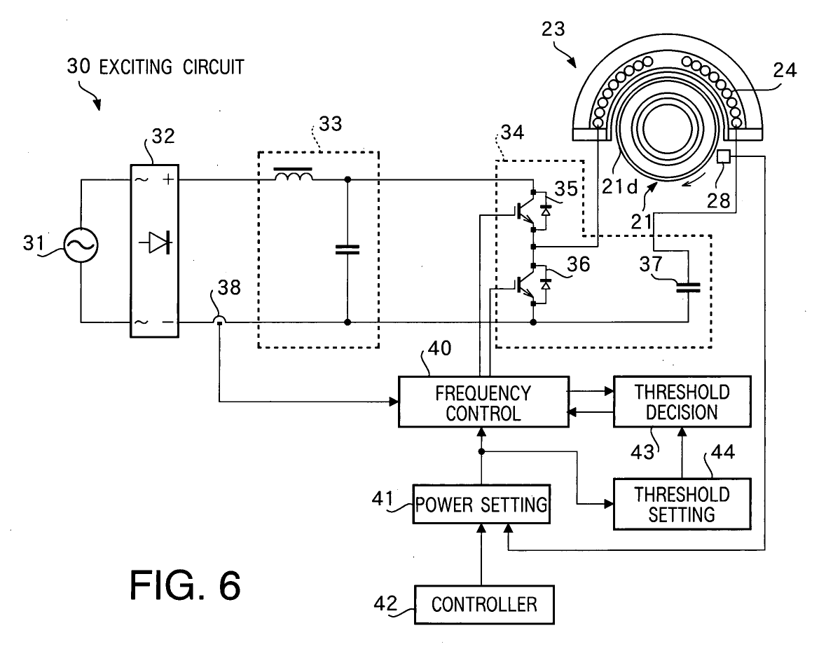

FIG. 6 shows the configuration of exciting circuit 30. Exciting circuit 30 supplies DC power or pulsating current power obtained by rectifying commercial power supply 31 with a rectifying device 32 and smoothing it with a smoothing circuit 33 to an inverter 34. Inverter 34 generates a high-frequency current by driving switching elements 35 and 36, and supplies this high-frequency current to exciting coil 24. By this means, a high-frequency field—that is, an induction field—is generated from exciting coil 24, and heat-producing belt 21d is induction-heated.

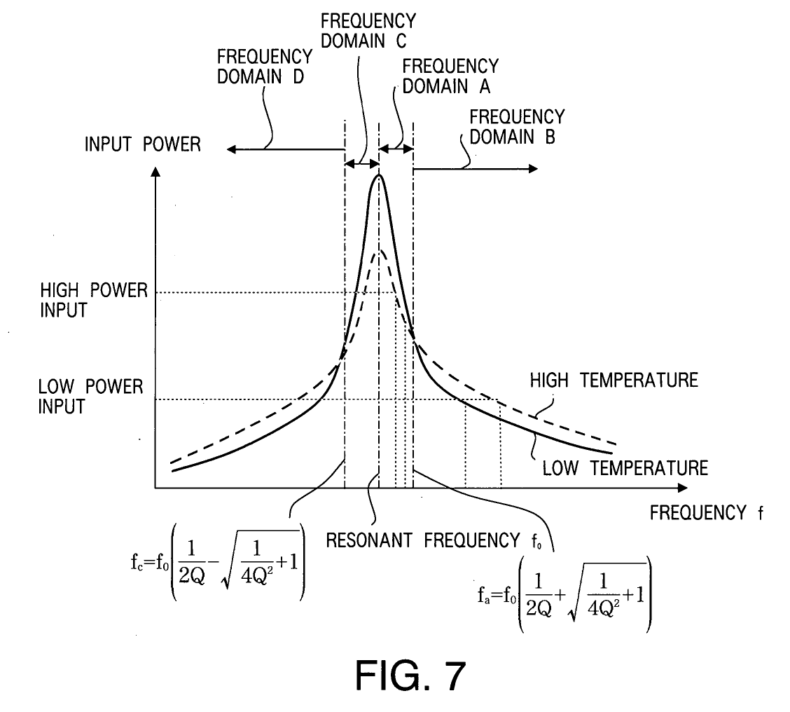

In this embodiment, a resonant capacitor 37 is directly connected in series to exciting coil 24, and thus inverter 34 has an SEPP (single-ended push-pull) inverter configuration. Therefore, exciting circuit 30 constitutes a circuit that drives an LCR series resonant circuit with exciting coil 24 and resonant capacitor 37 as a capacitor as a load by means of an AC constant-voltage power supply. An advantage of this circuit is that large input power is obtained by driving at a frequency close to LCR series resonant circuit resonant frequency f₀ for an exciting coil 24 load with a small impedance real component (for example, 2 Ω or less). Also, the input power characteristic is such that resonance Q factor as shown by the solid line in FIG. 7 with LCR series resonant circuit resonant frequency f₀ as the peak is large, and input power varies steeply with respect to frequency.

Here, when the temperature of heat-producing belt 21d rises, the impedance real component of exciting coil 24 increases, and therefore resonance Q factor of the direct resonant circuit of exciting coil 24 and resonant capacitor 37 decreases, so that the input power characteristic varies as shown by the dotted line in FIG. 7 in accordance with temperature variations.

A controller 42 specifies the power set by a power setting section 41 according to various operating modes, such as warm-up mode and fixing operation mode. Power setting section 41 sets a power value corresponding to the mode, and sends this to a frequency control section 40.

Here, power setting section 41 corrects the set power value according to the temperature detected by temperature sensor 28. For example, irrespective of the fact that the set power value in fixing operation mode is 500 W and the target fixing temperature is 170° C., when the temperature measured by temperature sensor 28 is 160° C., a corrected set power value slightly larger than 500 W is sent to frequency control section 40.

Frequency control section 40 provides for the power supplied to exciting coil 24 to become the set power by controlling the switching frequency of switching elements 35 and 36 according to the set power value and the current value detected by a current detection section 38. That is to say, frequency control section 40 controls the switching frequency so that the input current value becomes a predetermined value.

Specifically, the input power frequency characteristics shown in FIG. 7 are used. That is to say, the operating point of exciting circuit 30 is not placed at resonant frequency f₀ of the series resonant circuit of exciting coil 24 and resonant capacitor 37, but is placed at a position shifted toward either the higher-frequency or lower-frequency side of resonant frequency f₀. Then exciting circuit 30 is used in the domain in which input power varies according to drive frequency variations. In this embodiment, the operating point is shifted toward the higher-frequency side as shown by the arrow in frequency domain A or frequency domain B in FIG. 7. Then the switching frequency is decreased when power is to be increased, and the switching frequency is increased when power is to be decreased.

If the operating point of exciting circuit 30 is shifted from the resonant frequency toward the lower-frequency side as shown by the arrow in frequency domain C or frequency domain D in FIG. 7, the relationship between the level of the switching frequency and the level of the input power need only be reversed.

The switching frequency controlled by frequency control section 40 is sent to a threshold decision section 43. A threshold value set by a threshold setting section 44 according to the set power is input to threshold decision section 43. Threshold value setting by threshold setting section 44 is performed based on the input power, and the temperature-frequency characteristics of inverter 34 and exciting coil 24 as shown in FIG. 7.

As the low-temperature input power frequency characteristic shown by the solid line in FIG. 7 changes to the high-temperature input power frequency characteristic shown by the dashed line in FIG. 7 when the temperature rises, the necessity of varying the switching frequency in order to make the input power constant (that is, to maintain the power supplied to exciting coil 24 at the set power) is considered. When the operating point of exciting circuit 30 is shifted toward the higher-frequency side of resonant frequency f₀ of the series resonant circuit of exciting coil 24 and resonant capacitor 37, as in this embodiment, the operation of frequency control section 40 that makes the input power constant differs for frequency domain A for which the switching frequency is less than, and frequency domain B for which the switching frequency is greater than,

$${f}_{a} = {f}_{0} ( \frac{1}{2 Q} + \sqrt{\frac{1}{4 {Q}^{2}} + 1} ) .$$

Frequency domain A is used in a mode in which large power input is necessary, and operation is performed so that frequency decreases as temperature rises, while in frequency domain B used in a mode in which small power input is necessary, operation is performed so that frequency increases as temperature rises. A threshold value corresponding to the frequency of a temperature recognized as an excessive rise in temperature is set for each power level in each mode.

When the operating point of exciting circuit 30 is shifted toward the lower-frequency side of resonant frequency f₀ of the series resonant circuit of exciting coil 24 and resonant capacitor 37, the operation of frequency control section 40 that makes the input power constant differs for frequency domain C for which the switching frequency is greater than, and frequency domain D for which the switching frequency is less than,

$${f}_{c} = {f}_{0} ( \frac{1}{2 Q} - \sqrt{\frac{1}{4 {Q}^{2}} + 1} ) .$$

Frequency domain C is used in a mode in which large power input is necessary, and operation is performed so that frequency increases as temperature rises, while in frequency domain D used in a mode in which small power input is necessary, operation is performed so that frequency decreases as temperature rises. A threshold value corresponding to the frequency of a temperature recognized as an excessive rise in temperature is set for each power level in each mode. Threshold setting section 44 is actually a ROM (Read Only Memory) table in which threshold values corresponding to set power levels are stored.

Threshold decision section 43 compares the switching frequency controlled by frequency control section 40 with a threshold value corresponding to the power currently being supplied. When the operating point of exciting circuit 30 is shifted toward the higher-frequency side of the resonant frequency of the series resonant circuit of exciting coil 24 and resonant capacitor 37, as in this embodiment, in the case of operation in frequency domain A requiring large power input, if the comparison result shows that the switching frequency is less than or equal to the threshold value, threshold decision section 43 sends a comparison determination signal directing that off-control of switching elements 35 and 36 is to be performed to frequency control section 40. In the case of operation in frequency domain B requiring small power input, if the comparison result shows that the switching frequency is greater than or equal to the threshold value, threshold decision section 43 sends a comparison determination signal directing that off-control of switching elements 35 and 36 is to be performed to frequency control section 40. By this means, it is possible to prevent an excessive rise in temperature of heat-producing belt 21d.

When the operating point of exciting circuit 30 is shifted toward the lower-frequency side of the series resonant circuit of exciting coil 24 and resonant capacitor 37, in the case of operation in frequency domain C requiring large power input, if the comparison result shows that the switching frequency is greater than or equal to the threshold value, threshold decision section 43 sends a comparison determination signal directing that off-control of switching elements 35 and 36 is to be performed to frequency control section 40. In the case of operation in frequency domain D requiring small power input, if the comparison result shows that the switching frequency is less than or equal to the threshold value, threshold decision section 43 sends a comparison determination signal directing that off-control of switching elements 35 and 36 is to be performed to frequency control section 40.

Especially when the inductive resistance—that is, the impedance real component—of exciting coil 24 is small (for example, 1 Ω or less), as in a case where a low-resistance metal such as aluminum or copper is used as the material of heat-producing belt 21d, resonance Q factor of the series resonant circuit of exciting coil 24 and resonant capacitor 37 is large, and therefore the input power varies abruptly due to variations in the Q factor associated with temperature variations. Therefore, changes in the switching frequency can easily be detected, enabling heat-producing belt 21d temperature variations to be closely tracked without the occurrence of temperature detection delay.

In this embodiment, when operation of exciting circuit 30 is to be halted, a comparison determination signal indicating that off-control of switching elements 35 and 36 is to be performed is sent, but the operation halting method is not limited to this. For example, the power supply to the driver of switching elements 35 and 36 (not shown) may be halted, or commercial power supply 31 input to exciting circuit 30, inverter 34 DC power supply input, or the power supply to the driver of switching elements 35 and 36, may be cut by means of a relay.

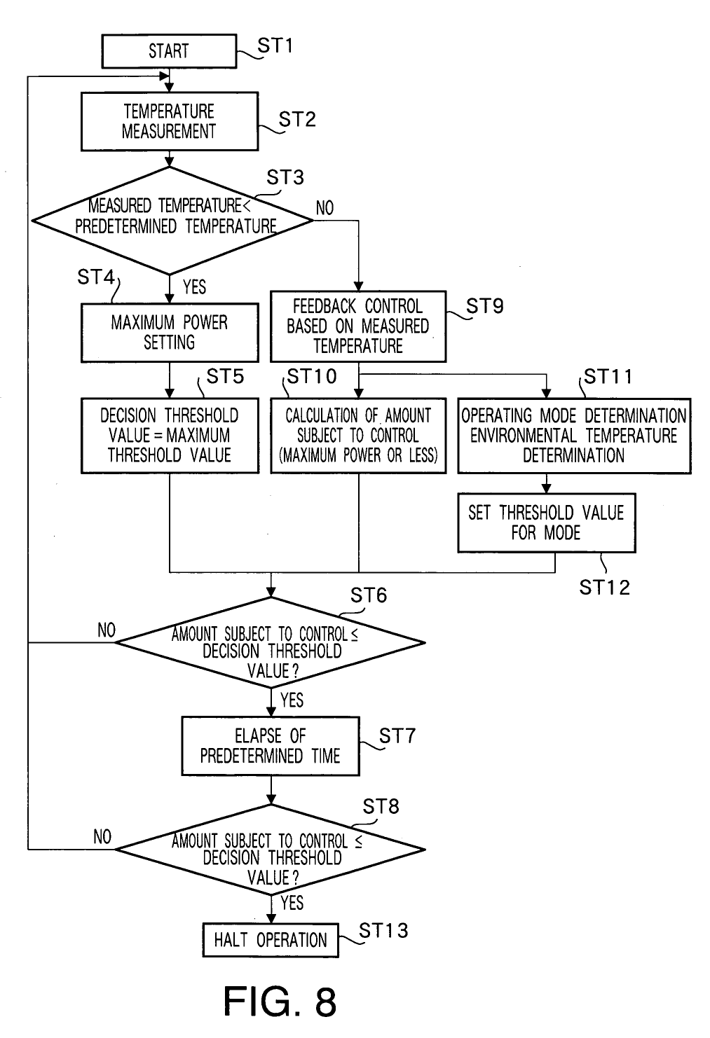

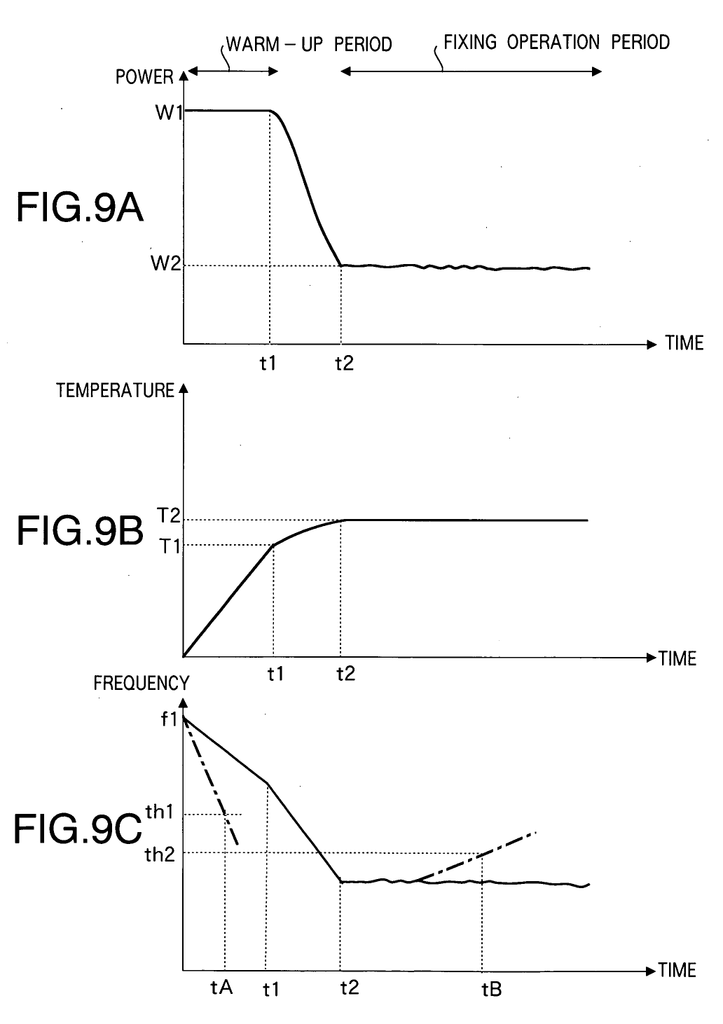

The operation of heat-fixing apparatus 20 will now be explained using FIG. 8, FIG. 9A, FIG. 9B, and FIG. 9C.

When processing is started in step ST1, heat-fixing apparatus 20 measures the temperature by means of temperature sensor 28 in step ST2, and determines in step ST3 whether or not the measured temperature is lower than a predetermined temperature. If the measured temperature is lower than the predetermined temperature, the processing flow proceeds to step ST4 and maximum power is set by power setting section 41, then maximum threshold value th1 corresponding to this maximum power is set as a decision threshold value by threshold setting section 44 in step ST5, and the processing flow proceeds to step ST6.

In step ST6, a threshold decision is made using the decision threshold value set in step ST5 and the amount subject to control (that is, the operation state amount constituting the basis of control). Actually, in this embodiment, the switching frequency generated by frequency control section 40 is used as the amount subject to control, and therefore in step ST6 a comparison is performed by threshold decision section 43 between the switching frequency and decision threshold value th1. In this embodiment, in a mode in which the maximum power is set after passing through step ST4, operation is performed in frequency domain A shown in FIG. 7, and therefore if the threshold decision result is that the switching frequency is less than or equal to decision threshold value th1, the processing flow proceeds to step ST8 via step ST7 (processing for waiting for the elapse of a predetermined time), and the same processing is performed as in step ST6.

Then, if an affirmative result is obtained in both step ST6 and step ST8, heat-producing belt 21d is determined to have risen excessively in temperature, the processing flow proceeds to step ST13, and supplying of current to exciting coil 24 by exciting circuit 30 is halted. On the other hand, if the decision result in either step ST6 or step ST8 is that the switching frequency is greater than the decision threshold value, the processing flow returns to step ST2.

Thus, in heat-fixing apparatus 20 according to this embodiment, when the frequency of a high-frequency current falls to or below a threshold value, the high-frequency current supply to exciting coil 24 is not halted immediately, but instead a threshold decision is made at predetermined time (for example, 0.1 second) intervals, and the current supply is halted based on a plurality of (for example, two) decisions. In other words, the current supply is halted after decision results indicating that the switching frequency has fallen to or below the threshold value have continued over a predetermined period.

By this means, it is possible to effectively avoid the problem of unnecessarily halting the current supply in response to a rise in temperature within a range that will not cause damage to heat-producing belt 21d. More specifically, it is possible to prevent erroneous detection of an excessive rise in temperature due to the effects of noise. Furthermore, it is also possible to avoid erroneous operation when the amount subject to control passes the threshold value transiently during mode switching. Moreover, using this approach makes it possible to prevent cutoff of the power supply due to an erroneous decision even if the threshold value for power supply cutoff is set to a value close to the normal operating range, enabling damage due to an excessive rise in temperature of heat-producing belt 21d to be prevented more dependably.

In addition, in this embodiment, a minimum wait time is set from acquisition of a first affirmative result in a threshold decision until the current supply is actually halted, and therefore the product of the continuous period of decision results indicating that the switching frequency has fallen to or below the threshold value, and the threshold value, or the switching frequency time integral, may be calculated in this period. In short, an amount obtained by multiplying the operation state amount by the time dimension (that is, computation amount=power×time) is calculated. That is to say, whereas an operation state amount has a relationship to power, this computation amount has a relationship to the amount of heat. As it has a relationship to the amount of heat, it can be said that it also has a relationship to the amount of temperature rising. Therefore, with this computation amount, correspondence is established to at least the minimum temperature of heat-producing belt 21d, and it is possible to measure temperature variations of heat-producing belt 21d more accurately. Thus it is possible to make a setting so that current cutoff is performed only when a predetermined amount of heat is input to heat-producing belt 21d and a predetermined temperature (for example, the thermostat supply halting temperature described in a later embodiment) is consequently reached.

In this embodiment, processing that halts the current supply has been described as the most suitable form of step ST13. However, processing may be executed in step ST13 that, instead of halting the current supply, suppresses the current supply to a level that enables damage due to an excessive rise in temperature of heat-producing belt 21d to be prevented.

Here, the processing loop from step ST2 through step ST8 corresponds to the warm-up time (that is, warm-up mode) processing in FIG. 9A, FIG. 9B, and FIG. 9C. That is to say, induction heating of heat-producing belt 21d is performed at maximum power W1 up to a predetermined temperature (for example 150° C.) lower than the fixing temperature (for example, 170° C.), measuring the temperature with temperature sensor 28. At this time the resistivity of the heat-producing layer of heat-producing belt 21d changes due to the rise in temperature, and it is therefore necessary to lower frequency f in order to supply a constant maximum power W1. In this embodiment, exciting circuit 30 raises the temperature of heat-producing belt 21d while maintaining maximum power W1 (for example, W1=1000W) by having frequency flowered in accordance with the rise in temperature.

Specifically, in the warm-up period, frequency control section 40 starts driving switching elements 35 and 36 at a frequency f1 that maintains maximum power W1. In this warm-up period, the temperature of heat-producing belt 21d rises steeply, but for reasons related to the heat transfer speed, the speed of the rise in temperature of exciting coil 24 is slower than that of heat-producing belt 21d. In order to supply constant power to exciting coil 24 in these circumstances, frequency control section 40 successively reduces the frequency of the high-frequency current in accordance with impedance variation attributable only to heat-producing belt 21d.

Threshold value th1 used by threshold decision section 43 in the warm-up period corresponds to impedance variation attributable only to heat-producing belt 21d.

Then, when a predetermined temperature T1 is reached while the frequency is still higher than threshold value th1 corresponding to power W1, as shown in FIG. 9B, the warm-up period is terminated at time t1—that is, a negative result is obtained in step ST3, and the processing flow proceeds to step ST9.

On the other hand, if the frequency falls to threshold value th1 or below at time tA before predetermined temperature T1 is reached, as shown in FIG. 9C, this means that the temperature of heat-producing belt 21d has risen excessively and exceeds the permissible temperature, and therefore the processing flow proceeds from step ST8 to step ST13, operation of inverter 34 is stopped, and the power supply to exciting coil 24 is halted.

When heat-fixing apparatus 20 terminates the step ST2 through step ST8 warm-up period and proceeds to step ST9, it enters the fixing operation period (that is, the fixing operation mode), and performs feedback control based on the temperature measured by temperature sensor 28. This is done by having power setting section 41 compare target temperature T2 for the fixing operation period with the measured temperature, finely adjust fixing operation period set power W2 according to the difference, and send set power W2 to frequency control section 40.

In step ST10, threshold setting section 44 calculates the amount subject to control corresponding to fixing operation period set power T2 (in this embodiment, frequency decision threshold value th2). Also, in step ST11, the operating mode (for example, temperature-maintenance operating mode, thin-paper printing mode, normal-paper printing mode, thick-paper printing mode, or the like) is determined, and the environmental temperature is measured. This environmental temperature is measured by means of a temperature sensor (not shown). In step ST12, a threshold value corresponding to the operating mode is set taking the environmental temperature into consideration.

Here, the fact that the temperature of exciting coil 24 becomes proportionally lower than the temperature of heat-producing belt 21d as the environmental temperature becomes lower is considered. Then a threshold value is set, for example, such that the power supply is more prone to be halted the lower the environmental temperature is. This makes it possible to halt the current supply with greater certitude in accordance with an excessive rise in temperature of heat-producing belt 21d. Actually, the power values supplied to exciting coil 24 are changed when in a low-temperature environment and when in a high-temperature environment, and therefore an excessive rise in temperature of heat-producing belt 21d can be prevented with greater certitude by changing the threshold value in accordance with these power values.

After setting the threshold value for use during a fixing operation period in this way, heat-fixing apparatus 20 proceeds to step ST6. Then a threshold decision is made in the same way as in the warm-up period, but in this embodiment, since power W2 required in the fixing operation period is small, the fact that the relationship between temperature variation and switching frequency variation is the reverse of that in the warm-up period is considered. That is to say, when the switching frequency under constant power reaches threshold value th2 or above, the power supply to exciting coil 24 is halted, preventing an excessive rise in temperature of heat-producing belt 21d. The inequality signs in the conditional expressions in ST6 and ST8 in FIG. 8 correspond to the description of warm-up period operation according to this embodiment, but are not limited to these signs, and are decided upon simultaneously with threshold value calculation in ST5 and ST12 according to the characteristics of the amount subject to control. That is to say, the direction of the inequality sign at the time of a decision is included in the decision threshold value. In the fixing operation period, the temperature of exciting coil 24 is equal to the temperature of heat-producing belt 21d. In order to supply constant power to exciting coil 24 in these circumstances, frequency control section 40 changes the frequency of the high-frequency current in accordance with impedance variation attributable to heat-producing belt 21d and also exciting coil 24.

Also, unlike threshold value th1 used by threshold decision section 43 in the warm-up period, threshold value th2 used by threshold decision section 43 in the fixing operation period corresponds to impedance variation attributable to heat-producing belt 21d and also exciting coil 24.

This fixing operation period set power W2, the temperature measured by temperature sensor 28, and the relationship between the switching frequency and decision threshold value th2, are shown in FIG. 9A, FIG. 9B, and FIG. 9C. For the sake of simplicity, in FIG. 9A, FIG. 9B, and FIG. 9C a case is illustrated in which the fixing operation period operating mode is assumed to be one of temperature-maintenance operating mode, thin-paper printing mode, normal-paper printing mode, or thick-paper printing mode, the set power corresponding to that operating mode is W2, and the decision threshold value corresponding to that set power is th2.

As shown in FIG. 9A, FIG. 9B, and FIG. 9C, when the measured temperature reaches fixing operation period target temperature T2 at time t2, the set power is taken to be W2, and the switching frequency is controlled so as to maintain this power. In this fixing operation, there is no problem if heat-producing roller 21 rotates normally, and the temperature of heat-producing belt 21d can be detected by temperature sensor 28 installed downstream of excitation unit 23. However, if heat-producing roller 21 halts, or dust or the like adheres to temperature sensor 28, for example, even if the part of heat-producing belt 21d facing excitation unit 23 reaches an excessively high temperature, temperature sensor 28 will not be able to detect this.

However, with heat-fixing apparatus 20 of this embodiment, in this case also, when the temperature of heat-producing belt 21d rises the temperature of exciting coil 24 installed in the extremely close vicinity thereof also rises accordingly. At this time, frequency control section 40 attempts to maintain the supplied power at fixed value W2, and therefore the frequency rises as shown in FIG. 9C. Eventually, when the frequency reaches or exceeds threshold value th2 corresponding to supplied power W2 at time tB, the temperature of heat-producing belt 21d is determined by threshold decision section 43 to have risen excessively, and off-control of inverter 34 operation is performed by frequency control section 40. By this means, the high-frequency current supply to exciting coil 24 is halted. As a result, an excessive rise in temperature of heat-producing belt 21d can be prevented dependably.

Thus, according to the above-described configuration, in exciting circuit 30 that supplies a high-frequency current to exciting coil 24 there are provided a plurality of threshold values corresponding to the power supplied in various modes, and by detecting an excessive rise in temperature by comparing the frequency of a high-frequency current necessary to supply set power to exciting coil 24 with the corresponding threshold value and halting the current supply, it is possible to implement a heat-fixing apparatus 20 that enables deformation due to an excessive rise in temperature of a heating member (heat-producing belt 21d) to be avoided dependably in all modes. Furthermore, the above-described effect can be achieved with a simple configuration provided only with a comparator that compares an operation state amount with a threshold value.

Also, the following effect can be obtained by applying the present invention to heat-fixing apparatus 20 that induction-heats heat-producing belt 21d functioning as a heating member fitted to the surface of heat-producing roller 21 by means of exciting coil 24 of excitation unit 23 installed along the outer periphery of heat-producing roller 21. Namely, with such a heat-fixing apparatus 20, the distance between heat-producing belt 21d and excitation unit 23 is extremely small, and due to space limitations it is difficult to install a temperature sensor in immediate proximity to the actual heat-producing part, but an excessive rise in temperature of heat-producing belt 21d is detected according to the frequency of a high-frequency current supplied to exciting coil 24 located in the extremely close vicinity of heat-producing belt 21d, and the applied voltage, and the high-frequency current supply is halted, enabling damage due to an excessive rise in temperature of heat-producing belt 21d to be effectively avoided when the heating member fitted to the surface of heat-producing roller 21 is heated by exciting coil 24 from its outer side.

### Embodiment 2

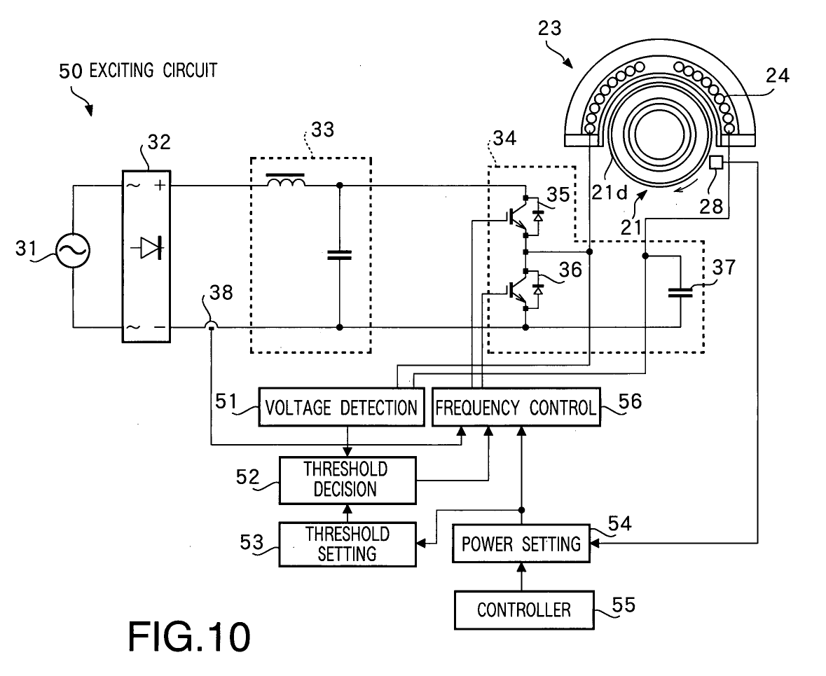

FIG. 10, in which parts corresponding to those in FIG. 6 are assigned the same codes as in FIG. 6, shows the configuration of an exciting circuit 50 according to Embodiment 2 of the present invention. Exciting circuit 50 is used instead of exciting circuit 30 in heat-fixing apparatus 20 described in Embodiment 1.

In the case of exciting circuit 30 of Embodiment 1, variation of the frequency of a high-frequency current necessary to supply constant power to exciting coil 24 is detected, and the current supply to exciting coil 24 is halted. By contrast, in the case of exciting circuit 50 of this embodiment, variation of an applied voltage necessary to supply constant power to exciting coil 24 is detected, and the current supply to exciting coil 24 is halted. That is to say, in this embodiment, an applied voltage is used instead of a switching frequency as an operation state amount constituting the basis of control. However, the circuit configuration for detecting variation of the applied voltage is not limited to exciting circuit 50 described in this embodiment, and implementation is also possible with circuits of various other configurations.

Exciting circuit 50 detects a voltage applied to exciting coil 24 in a voltage detection section 51, and sends the detection result to a threshold decision section 52. A power setting section 54 sets a power value corresponding to each operating mode specified by a controller 55, and sends this to a frequency control section 56 and threshold setting section 53. Threshold setting section 53 comprises a memory table, and sends the threshold value corresponding to a power value to threshold decision section 52. The result of a decision by threshold decision section 52 is sent to frequency control section 56.

Based on a current value obtained by current detection section 38, frequency control section 56 varies the switching frequency of inverter 34 so that the power supplied to exciting coil 24 becomes the value set by power setting section 54.

In addition, when a decision result indicating that the detected voltage is less than or equal to the threshold value is obtained from threshold decision section 52, frequency control section 56 turns inverter 34 off. That is to say, frequency control section 56 halts the current supply to exciting coil 24 by turning off switching elements 35 and 36.

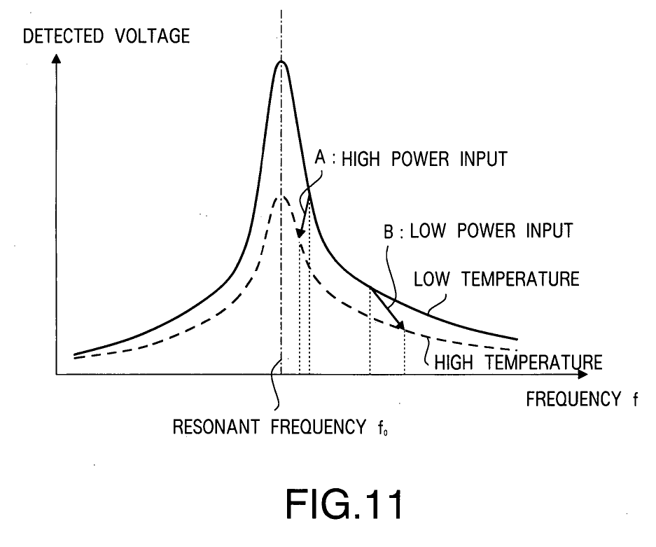

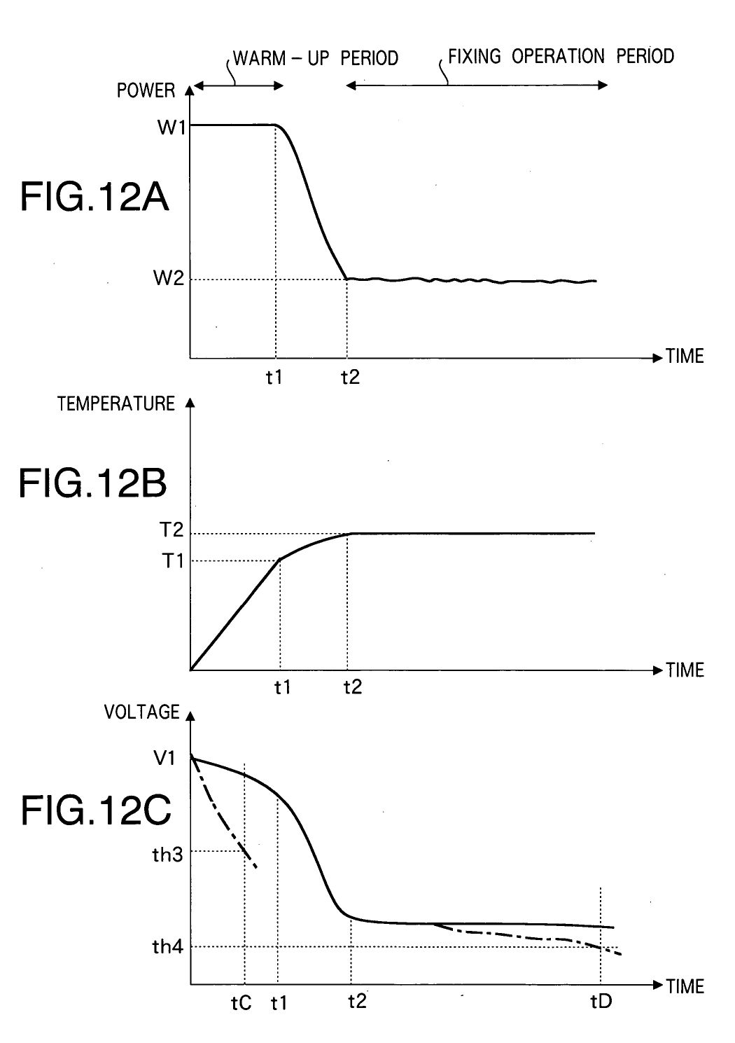

The operation of heat-fixing apparatus 20 of this embodiment will now be explained using FIG. 11, FIG. 12A, FIG. 12B, and FIG. 12C. FIG. 11 is a graph showing the relationship between the switching frequency and the voltage detected by voltage detection section 51. In this embodiment, the series resonant circuit of exciting coil 24 and resonant capacitor 37 is driven by a virtually constant voltage, and therefore the voltage detected by voltage detection section 51 decreases in all frequency domains with respect to an increase in the impedance real component accompanying a rise in temperature. In the heat-fixing apparatus 20 warm-up period, frequency control section 56 starts driving switching elements 35 and 36 at frequency f1 that maintains maximum power W1. In this warm-up period, the temperature of heat-producing belt 21d rises steeply, but for reasons related to the heat transfer speed, the speed of the rise in temperature of exciting coil 24 is slower than that of heat-producing belt 21d. In order to supply constant power to exciting coil 24 in these circumstances, frequency control section 56 successively reduces the frequency of the high-frequency current in accordance with impedance variation attributable only to heat-producing belt 21d. At this time, the applied voltage detected by voltage detection section 51 also decreases when the switching frequency decreases, as shown by arrow A in FIG. 11 and in FIG. 12C.

Then, when predetermined temperature T1 is reached while the applied voltage is still higher than threshold value th3 corresponding to power W1, the warm-up period is terminated at time t1. On the other hand, if the applied voltage falls to threshold value th3 or below at time tC before predetermined temperature T1 is reached, frequency control section 56 stops the operation of inverter 34 and halts the current supply to exciting coil 24.

Threshold value th3 used by threshold decision section 52 in the warm-up period corresponds to impedance variation attributable only to heat-producing belt 21d.

From time t2 at which the temperature obtained from temperature sensor 28 becomes predetermined temperature T2, heat-fixing apparatus 20 enters the fixing operation period, and from this time t2, the set power is switched to W2. At this time, a threshold value th4 corresponding to power W2 is set by threshold setting section 53, and this is sent to threshold decision section 52.

Unlike threshold value th3 used by threshold decision section 52 in the warm-up period, threshold value th4 used by threshold decision section 52 in the fixing operation period corresponds to impedance variation attributable to heat-producing belt 21d and also exciting coil 24.

In the fixing operation period, threshold decision section 52 constantly makes threshold decisions using the voltage applied to exciting coil 24 and threshold value th4, and at time tD at which the applied voltage reaches threshold value th4 or below, directs frequency control section 56 to turn inverter 34 off. By this means it is possible prevent deformation due to an excessive rise in temperature of heat-producing belt 21d in a fixing operation period.

Thus, according to the above-described configuration, in exciting circuit 50 that supplies a high-frequency current to exciting coil 24 there are provided a plurality of threshold values corresponding to the power supplied in various modes, and by detecting an excessive rise in temperature by comparing the voltage applied to exciting coil 24 when a high-frequency current necessary to maintain a set power value is supplied to exciting coil 24 with the corresponding threshold value and halting the current supply, it is possible to implement a heat-fixing apparatus that enables deformation due to an excessive rise in temperature of a heating member (heat-producing belt 21d) to be avoided dependably in all modes, in the same way as in Embodiment 1.

### Embodiment 3

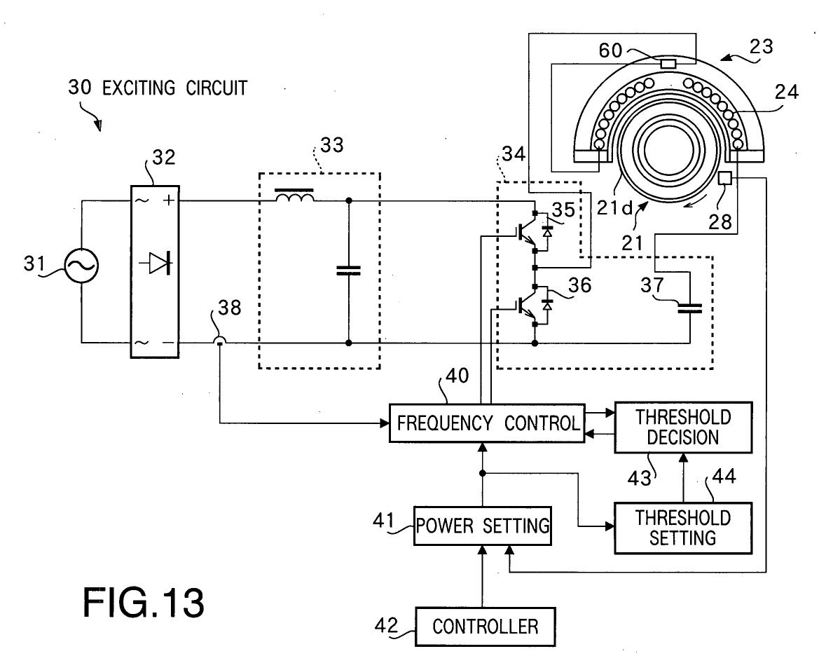

FIG. 13, in which parts corresponding to those in FIG. 6 are assigned the same codes as in FIG. 6, shows the configuration of an exciting circuit 30 according to Embodiment 3 of the present invention. This exciting circuit 30 is used instead of the exciting circuit 30 in heat-fixing apparatus 20 described in Embodiment 1. Heat-fixing apparatus 20 according to this embodiment supplies a high-frequency current obtained by means of inverter 34 to exciting coil 24 via thermostats 60.

In this embodiment, two thermostats 60 are installed connected in a cascade arrangement in the axial-direction center of center core 25a of rear core 25 as shown in FIG. 3 and FIG. 5. However, the number and installation location of thermostats 60 are not limited to this case, and any location may be used that enables an excessive rise in temperature of heat-producing belt 21d to be detected. In this embodiment, thermostats 60 cut the current at both ends when the temperature of an internal temperature-sensitive bimetallic member reaches 190° C., for example. The location of thermostats 60 in the electrical circuitry need not be directly prior to exciting coil 24. The only requirement is for them to be located so that operation of the exciting circuit stops, and they may cut the power supply to the driver (not shown) of switching elements 35 and 36, or may cut commercial power input to exciting circuit 30, or inverter 34 DC power input.

In basically the same way as in Embodiment 1, threshold setting section 44 and threshold decision section 43 set a threshold value for cutting the power supply for each set power, compare this threshold value with the frequency control section 40 switching frequency, and halt the power supply to exciting coil 24 when the switching frequency meets a predetermined condition.

In this embodiment, however, unlike the case of Embodiment 1, threshold setting section 44 sets only threshold value th1 (FIG. 9C) corresponding to supplied current W1 (FIG. 9A) in the warm-up period, and threshold decision section 43 makes a threshold decision using this threshold value th1 and the switching frequency only during warm-up.

That is to say, with heat-fixing apparatus 20 of this embodiment, in the warm-up period an excessive rise in temperature of heat-producing belt 21d is detected based on the frequency of the high-frequency current supplied to exciting coil 24 at fixed power, and the power supply is halted in accordance with the threshold decision result. In a fixing operation period, on the other hand, an excessive rise in temperature of heat-producing belt 21d is prevented by implementing a circuit break by means of thermostats 60.

Thus, with a heat-fixing apparatus of this embodiment, in a warm-up period in which the temperature of heat-producing belt 21d rises steeply, excessive temperature rise determination and power supply halting processing are applied by means of frequency threshold decisions that allow close tracking of abnormal overheating for a steep rise in temperature and cutting of the power supply. On the other hand, in a fixing operation period in which the temperature of heat-producing belt 21d rises gradually, power supply halting processing by means of thermostats 60 is applied. By this means, it is possible to implement a heat-fixing apparatus in which an excessive rise in temperature of heat-producing belt 21d can be prevented dependably in both a warm-up period and a fixing operation period.

Also, by having thermostats 60 handle a current supply halting operation in response to an excessive rise in temperature in a fixing operation period, the amount of processing handled by threshold decision section 43 and threshold setting section 44 can be reduced, and the configuration of exciting circuit 30 can be simplified accordingly.

### Embodiment 4

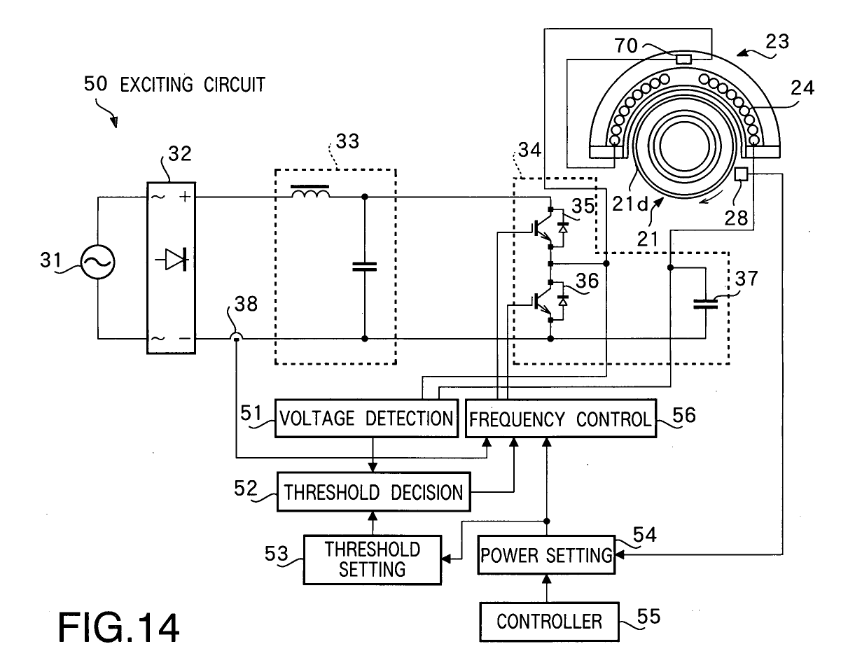

FIG. 14, in which parts corresponding to those in FIG. 10 are assigned the same codes as in FIG. 10, shows the configuration of an exciting circuit 50 according to Embodiment 4 of the present invention. Exciting circuit 50 is used instead of exciting circuit 30 in heat-fixing apparatus 20 described in Embodiment 1. Exciting circuit 50 supplies a high-frequency current obtained by means of inverter 34 to exciting coil 24 via thermostats 70. The arrangement and characteristics of these thermostats 70 are the same as those of thermostats 60 in Embodiment 3.

In basically the same way as in Embodiment 2, threshold setting section 53 and threshold decision section 52 set a threshold value for cutting the power supply for each set power, and compare this threshold value with the voltage applied to exciting coil 24 detected by voltage detection section 51. Then the current supply to exciting coil 24 is halted when the applied voltage falls to the threshold value or below.

In this embodiment, however, unlike the case of Embodiment 2, threshold setting section 53 sets only threshold value th3 (FIG. 12C) corresponding to warm-up supplied current W1 (FIG. 12A), and threshold decision section 52 makes a threshold decision using this threshold value th3 and the applied voltage only during warm-up.

That is to say, with heat-fixing apparatus 20 of this embodiment, in the warm-up period an excessive rise in temperature of heat-producing belt 21d is detected based on the voltage applied to exciting coil 24 at fixed power, and the current supply is halted in accordance with the threshold decision result. In a fixing operation period, on the other hand, an excessive rise in temperature of heat-producing belt 21d is prevented by implementing a circuit break by means of thermostats 70.

Thus, with heat-fixing apparatus 20 of this embodiment, in a warm-up period in which the temperature of heat-producing belt 21d rises steeply, excessive temperature rise determination and power supply halting processing are applied by means of applied voltage threshold decisions that allow close tracking of abnormal overheating for a steep rise in temperature and cutting of the power supply. On the other hand, in a fixing operation period in which the temperature of heat-producing belt 21d rises gradually, power supply halting processing by means of thermostats 70 is applied. By this means, it is possible to implement a heat-fixing apparatus in which an excessive rise in temperature of heat-producing belt 21d can be prevented dependably in both a warm-up period and a fixing operation period.

Also, by having thermostats 70 handle a current supply halting operation in response to an excessive rise in temperature in a fixing operation period, the amount of processing handled by threshold decision section 52 and frequency control section 56 can be reduced, and the configuration of exciting circuit 50 can be simplified accordingly.

### Embodiment 5

In above Embodiments 3 and 4, cases have been described in which an excessive rise in temperature of a heating member (heat-producing belt 21d) during the warm-up period is prevented by exciting circuit 30 or 50, and an excessive rise in temperature during the fixing operation period is prevented by thermostats 60 or 70. With this embodiment, on the other hand, a heat-fixing apparatus is proposed in which an excessive rise in temperature during the warm-up period and during the fixing operation period is prevented by exciting circuit 30 or 50, and an excessive rise in temperature during the fixing operation period is prevented by thermostats 60 or 70.

Specifically, a configuration is used whereby exciting circuit 30 or 50 can cut the power supply in both the warm-up period and the fixing operation period by making threshold decisions corresponding to the warm-up period and the fixing operation period respectively with exciting circuit 30 or 50, as described in Embodiment 1 and Embodiment 2. In addition, by providing thermostats 60 or 70, it is also possible to cut the power supply with thermostats 60 or 70 during the fixing operation period.

By this means, in the warm-up period an excessive rise in temperature can be prevented by exciting circuit 30 or 50, and in the fixing operation period an excessive rise in temperature can be prevented by both exciting circuit 30 or 50 and thermostats 60 or 70. As a result, an excessive rise in temperature during the fixing operation period can be prevented more dependably than in Embodiments 1 through 4.

Assume, for example, that a situation arises during the fixing operation period in which temperature sensor 28 cannot accurately detect the surface temperature of heated heat-producing belt 21d due to an abnormality of some kind, such as stoppage of heat-producing roller 21 or adhesion of foreign matter to temperature sensor 28. In this case, the temperature of heat-producing belt 21d becomes abnormal instantaneously, and there is a risk of the surface of heat-producing belt 21d being deformed. In a temperature rise of this kind, the rate of increase of the temperature of heat-producing belt 21d may be as great as 15° C./second, for example. Therefore, the circuit cannot be broken with non-contact thermostats 60 or 70, which operate by means of thermal conduction, since the bimetallic elements of thermostats 60 or 70 do not reach the cutoff set temperature (for example, 200° C.).

However, even in the case of a sharp rise in temperature during the fixing operation period of this kind, the current supply to exciting coil 24 can be halted by means of exciting circuit 30 or 50, enabling an excessive rise in temperature of heat-producing belt 21d to be obviated. Naturally, when the temperature of heat-producing belt 21d rises gradually, the current supply to heat-producing belt 21d is halted by means of thermostats 60 or 70.

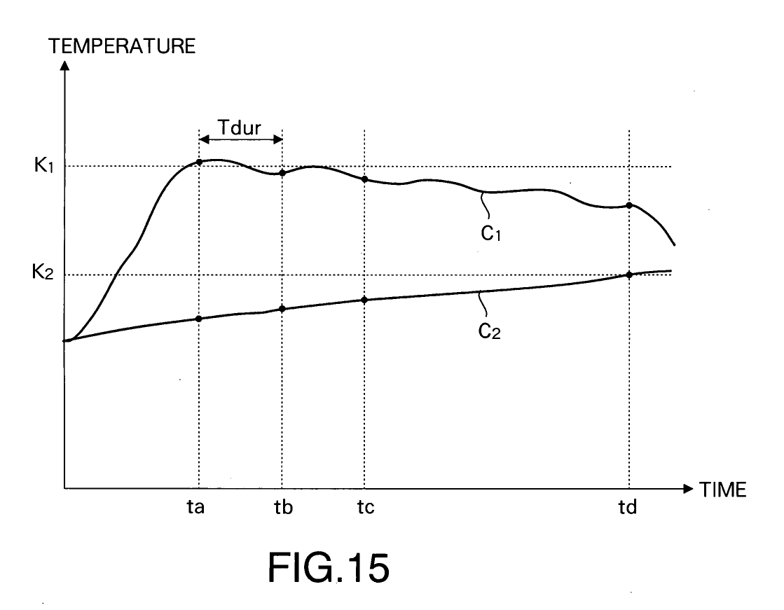

In this embodiment, the temperature at which the current supply is halted by exciting circuit 30 or 50 is set higher than the temperature at which supply is halted by thermostats 60 or 70. In other words, fixing operation period threshold value setting is performed so that heat-producing belt 21d temperature K₁ when the current supply is halted as the result of a threshold decision is higher than thermostat 60 or 70 supply halting temperature K₁, as shown in FIG. 15. In FIG. 15, curve C₁ indicates variation in the temperature of heat-producing belt 21d recognized as a result of operation state amount control or detection, and curve C₂ indicates variation in the temperature of thermostats 60 or 70.

That is to say, exciting circuit 30 or 50 counters the risk of damage to heat-producing belt 21d due to an instantaneous abnormally high temperature, while thermostats 60 or 70 counter the risk of damage to heat-producing belt 21d due to the continuation of a temperature slightly lower than an abnormally high temperature over a comparatively long period of time. As a result, it is possible to implement current supply halting processing that takes account of damage due to an actual excessive rise in temperature of heat-producing belt 21d. In the example shown in FIG. 15, since the temperature of heat-producing belt 21d continues to exceed temperature K₂ for a comparatively long period of time, thermostats 60 or 70 cut the current supply at time td.

In this embodiment, threshold decisions are made at predetermined time intervals and current cutoff is performed based on a predetermined number of decisions, in the same way as in the above-described embodiments. In other words, the current supply is halted after decision results affirming execution of current supply halting have continued for a predetermined time. For example, as shown in FIG. 15, a decision result affirming execution of current supply halting is obtained in the threshold decision at time ta, but a decision result affirming execution of current supply halting is not obtained in the threshold decision at time tb after the elapse of a predetermined time period (Tdur). Therefore, the current supply is not halted at time tb. In this way it is possible to avoid unnecessary cutoff of the current supply by exciting circuit 30 or 50 which have good tracking capability even in the event of a short-time rise in temperature that is unlikely to actually damage heat-producing belt 21d. It is thus possible to effectively halt the current supply only when there is a risk of damage to heat-producing belt 21d.

Furthermore, in this embodiment, as in the above-described embodiments, a minimum wait time is set from acquisition of a first affirmative result in a threshold decision until the current supply is actually halted, and therefore the product of the continuous period of decision results indicating that the switching frequency has fallen to or below the threshold value, and the threshold value, or the switching frequency time integral, may be calculated in this period. In short, an amount obtained by multiplying the operation state amount by the time dimension (that is, computation amount=power×time) is calculated. By this means it is possible to predict temperature variations of heat-producing belt 21d more accurately.

Thus, according to the above-described configuration, by providing thermostats 60 or 70 in addition to exciting circuit 30 or 50 of Embodiment 1 or Embodiment 2, it is possible to implement a heat-fixing apparatus in which an excessive rise in temperature in a fixing operation period can be prevented more dependably than in Embodiments 1 through 4.

### Other Embodiments

In the above embodiments, cases have been described in which inverter 34 has a so-called SEPP configuration, but the circuit configuration of inverter 34 is not limited to this.

Also, in the above embodiments, a high-frequency current frequency or applied voltage is used as an operation state amount subject to a threshold decision, but the present invention is not limited to this. Details are given below concerning the kinds of operation state amounts than can be used as objects of threshold decisions, as well as exciting coil 24 and heat-producing belt 21d temperature rises and exciting coil 24 impedance variations.

Although exciting coil 24 is located close to heat-producing belt 21d, the temperature of exciting coil 24 does not rise rapidly in the event of a short-time rise in temperature of heat-producing belt 21d. In the case of a short-time temperature rise of this kind, while the temperature of heat-producing belt 21d rises and the resistance value of heat-producing belt 21d increases, the direct current resistance value of exciting coil 24 does not change. In this case, the inductive resistance component of the impedance of exciting coil 24 varies. For example, in the case of a heat-producing belt 21d using a highly electrically conductive material such as aluminum, copper, or silver, a variation is shown in which the real component of the impedance increases with respect to a rise in temperature. However, depending on the material and specifications of heat-producing belt 21d, the real component of the impedance may decrease. Furthermore, the sensitivity of impedance variations with respect to temperature variations varies according to the configuration of the magnetic circuit that passes through exciting coil 24 and heat-producing belt 21d.

On the other hand, in the case of continuous operation, for example, heat-producing belt 21d reaches a high temperature, and the temperature of exciting coil 24 becomes equally high through heat transfer. In such a state, the direct current resistance of exciting coil 24 increases as the temperature rises, and therefore the real component of the impedance of exciting coil 24 increases. The increase in direct current resistance in this case is decided only by the material and temperature of exciting coil 24, and is substantially unaffected by other configuration factors. Therefore, in order to estimate a change in temperature of heat-producing belt 21d, it is necessary to subtract the amount of resistance change due to a change in temperature of exciting coil 24 from a change in impedance of exciting coil 24.

Thus the nature of exciting coil 24 impedance variations differs according to differences in the operating mode, immediately after a rise in temperature and during continuous operation. It is possible for the nature of variations immediately after a rise in temperature and during continuous operation to become the same, but in this case, also, the causes of the variations differ. It is therefore necessary to use different procedures for estimating heat-producing belt 21d temperature variations from impedance variations according to the operating mode.

A circuit operation state amount varies in exciting circuit 30 or 50 in accordance with exciting coil 24 impedance variations. The type and properties of an operation state amount that varies differ according to the configuration of the exciting circuit.

For example, when exciting coil 24 is driven by a constant-voltage power supply, the drive current of exciting coil 24 decreases due to an increase in impedance. Therefore, the minimum value of the exciting coil 24 drive current can be set as a threshold value. In this case, since the input power also decreases, when inverter 34 is driven at a constant voltage the current supplied to inverter 34 decreases, and when inverter 34 is driven at a constant current the voltage supplied to inverter 34 decreases. Therefore, the minimum value of the inverter 34 supply current or supply voltage can be set as a threshold value.

Also, when exciting coil 24 is driven by a low-current power supply, an increase in impedance is detected as a rise in the exciting coil 24 drive voltage. Therefore, the maximum value of the exciting coil 24 drive voltage can be set as a threshold value. In this case, since the input power increases, when inverter 34 is driven at a constant voltage the current supplied to inverter 34 increases, and when inverter 34 is driven at a constant current the voltage supplied to inverter 34 increases. Therefore, the maximum value of the inverter 34 supply current or supply voltage can be set as a threshold value.

Furthermore, in exciting circuit 30 or 50 for which constant power control is performed, a control parameter used in power control varies greatly in line with impedance variations. Therefore, a control parameter can be set as a threshold value. For example, in the case of exciting circuit 30 or 50 to which constant current control is applied using the on-duty ratio of inverter 34, a decrease in the load current due to an increase in impedance is compensated for automatically by an increase in the on-duty cycle. Therefore, the maximum value of the on-duty cycle can be set as a threshold value.

Thus, an operation state amount appropriate to the configuration of exciting circuit 30 or 50 is selected and set as a threshold value, an operation state amount that varies according to the operating mode is compared with the threshold value for each operating mode, and the supply of a high-frequency current to the exciting coil is halted or suppressed in accordance with the result of the comparison. As a result, the current supply to heat-producing belt 21d can be halted or suppressed easily and rapidly in the event of abnormal overheating of heat-producing belt 21d in all operating modes.

In the above embodiments, a heat-fixing apparatus 20 has been described in which an excitation unit 23 is installed on the outer periphery of a heat-producing roller 21 with a heat-producing belt 21d fitted to its surface, and heat-producing belt 21d is induction-heated by an exciting coil 24 incorporated in this excitation unit 23. However, the present invention is not limited to this. For example, the same kind of effects as in the above-described embodiments can also be obtained if the present invention is applied to a heat-fixing apparatus with a different configuration in which an exciting coil is installed inside a circular film or roller and a heating member is induction-heated.

Also, in the above embodiments, cases have been described in which the supply of a high-frequency current to exciting coil 24 is halted when a decision result indicating an excessive rise in temperature is obtained in a threshold decision, but the present invention is not limited to this, and the high-frequency current supply may be suppressed by increasing the switching frequency of switching elements 35 and 36, or reducing the on-duty cycle, for example.

As described above, according to the present invention, by setting different threshold values for modes whose supply power values differ, making a threshold decision based on the frequency or applied voltage of a high-frequency power supply necessary to supply constant power corresponding to each mode to an exciting coil, using the threshold value for that mode, and cutting or suppressing the high-frequency power supply according to the result of that threshold decision, it is possible to implement a heat-fixing apparatus that enables a rise in temperature of a heating member to be closely tracked, and an excessive rise in temperature of the heating member to be obviated, by means of a simple configuration.

This application is based on Japanese Patent Application No. 2003-043129 filed on Feb. 20, 2003, the entire content of which is expressly incorporated by reference herein.

### INDUSTRIAL APPLICABILITY

The present invention has an effect of enabling a rise in temperature of a heating member to be closely tracked, and an excessive rise in temperature of the heating member to be obviated, by means of a simple configuration and irrespective of differences in the operating mode, such as immediately after a rise in temperature or during continuous operation, and is applicable to a heat-fixing apparatus that fixes unfixed toner by means of heating used in a copier, printer, facsimile, or the like, for example.

1. A heat-fixing apparatus having a plurality of operating modes for induction-heating a heating member by means of an induction field and fixing a heated image to recording paper, said heat-fixing apparatus comprising:
an exciting circuit that supplies a high-frequency current in accordance with set power corresponding to said operating mode; and
an exciting coil that generates an induction field by supply of a high-frequency current from said exciting circuit; wherein
said exciting circuit sets a threshold value relating to that operating state amount based on said set power, compares an operating state amount when a high-frequency current is supplied with said threshold value, and halts or suppresses high-frequency current supply according to a comparison result.

2. The heat-fixing apparatus according to claim 1, wherein said exciting circuit halts or suppresses high-frequency current supply when comparison results indicating that supply halting or suppression is to be executed continue over a predetermined period of time.

3. The heat-fixing apparatus according to claim 1, wherein said exciting circuit calculates either a product of a continuous period of decision results indicating that it has been affirmed that supply halting or suppression is to be executed and said threshold value, or an integral of operation state amounts, in said continuous period.

4. The heat-fixing apparatus according to claim 1, wherein said exciting circuit makes said threshold value variable based on environmental temperature.

5. The heat-fixing apparatus according to claim 1, further comprising a thermostat that is located in a vicinity of said heating member and halts high-frequency current supply to said exciting coil from said exciting circuit when a predetermined supply halting temperature or higher is reached; wherein
said exciting circuit performs halting or suppression of high-frequency current supply in a first operating mode of said plurality of operating modes; and
said thermostat performs halting of high-frequency current supply in a second operating mode of said plurality of operating modes.

6. The heat-fixing apparatus according to claim 1, further comprising a thermostat that is located close to said heating member and halts high-frequency current supply to said exciting coil from said exciting circuit when a predetermined supply halting temperature or higher is reached; wherein
said thermostat performs halting of high-frequency current supply in a first operating mode of said plurality of operating modes; and
said exciting circuit at least performs halting or suppression of high-frequency current supply in said first operating mode, and also sets a threshold value in said first operating mode so that a temperature of said heating member when high-frequency current supply is halted or suppressed becomes higher than a supply halting temperature of said thermostat.

7. The heat-fixing apparatus according to claim 1, wherein:
said exciting circuit has an inverter circuit that generates a high frequency by DC power supply or pulsating current power supply switching; and
said operation state amount is any one of a switching frequency of said inverter circuit, an on-duty ratio of said inverter circuit, a voltage applied to said exciting coil, a current applied to said exciting coil, a voltage supplied to said inverter circuit, and a current supplied to said inverter circuit.

8. The heat-fixing apparatus according to claim 1, wherein:
said heating member is fitted to a surface of a roller supported rotatably; and
said exciting coil is mounted inside an excitation unit installed so as to follow a line of an outer peripheral surface of said roller.
